(19) United States
(12) Patent Application Publication
(10) Pub. No.: US 2015/0060146 A1
(43) Pub. Date: Mar. 5, 2015

(54) RESERVOIR ACTIVATED EMULSION BREAKING FOR LOST CIRCULATION

(71) Applicants: SECURE ENERGY (DRILLING SERVICES) INC., Calgary (CA); LARICINA ENERGY LTD., Calgary (CA)

(72) Inventors: PATRICK BRUNELLE, Langdon (CA); CAMERON JAMES GEDDES, Okotoks (CA)

(21) Appl. No.: 14/473,823

(22) Filed: Aug. 29, 2014

Related U.S. Application Data
(60) Provisional application No. 61/874,144, filed on Sep. 5, 2013.

(51) Int. Cl. C09K 8/28; E21B 21/00; C09K 8/42

(52) U.S. Cl. CPC C09K 8/28; C09K 8/42; E21B 21/003
USPC 175/72; 507/135

(57) ABSTRACT

An oil-in-water emulsion is provided to place a sealant within a subterranean formation by being deployed into the formation to reacte with the formation's included water to break the emulsion, leaving the emulsified components, some of which act as the sealant to form at least a partial seal. The emulsion does not form a seal until emulsified in response to formation water conditions (salinity, pH, calcium ion concentration, temperature), and can be a drilling fluid or a pill during drilling activities.

### FIELD OF THE INVENTION

The present invention relates to an oil-in-water emulsion to remediate the loss of the drilling mud circulation while drilling a well. The emulsion may be used to prevent drilling fluids from entering a subterranean formation.

### BACKGROUND OF THE INVENTION

Drilling fluids are used to drill holes in the Earth's crust. The drilling fluids are typically circulated through the drill pipe, through the drill bit, then up to the surface through the annular space between the drill pipe and the formation. It is important for the drilling fluids to circulate down the hole and back up to the surface. The drilling fluids are used to:
a) seal permeable formation
b) maximize penetration rates
c) minimize reservoir damage
d) cool and lubricate the drilling bit
e) clean the drill bit nozzles
f) control formation pressures
g) maintain well bore stability
h) prevent the well from caving
i) power the drill bit
j) and, in some cases, provide a medium through which data can be transmitted to the surface

The loss of drilling fluid circulation increases the risk of:
a) possible blow out because of a drop in the mud level, or a failure to control formation pressure
b) possible sticking the drill pipe or drill bit because of poor cutting removal
c) excessive cost because of loss of mud, increasing rig time and remedial cementing operations
d) losses to the producing zone resulting in extensive formation damage which can negatively affect future oil or gas production
e) gas migration
f) and well bore instability

In extreme cases of lost circulation, almost all of the drilling fluids are lost to the formation. In those cases, the risk of blow out is significant. In addition, there is also a significant risk of getting the drill bit trapped in the hole. Extreme cases of lost circulation can be dangerous and cause significant down time which affects the economics of drilling a well. In some cases, it can cause $1,000,000 or more of additional cost to a well.

Traditionally, lost circulation materials are added to the drilling fluids to eliminate or reduce the loss of drilling fluids to the formation while drilling. Some examples are bentonite, polymer, solid polymer fibers (polyethylene, polypropylene, etc), sawdust, flaked cellophane, crushed or ground calcium carbonate, shredded newspaper, cotton seed hulls, and crushed walnut shells. However, such agents have not been proven satisfactory for extreme cases of lost circulation. In those cases, the traditional solution has been to increase the drill fluid injection volume by an order of magnitude or more, or by cementing the formation.

The use of an oil-in-water emulsion to seal a subterranean formation was first described by Weigand in 1957 (U.S. Pat. No. 2,805,720). In this case, an asphalt-in-water emulsion is forced through the formation that requires sealing. By forcing the emulsion through the formation, the emulsion breaks, the asphalt is freed and the asphalt forms a seal.

Another example came in 1964 by Brandt et al in (U.S. Pat. No. 3,159,976) where the use of a cationic asphalt emulsion to plug a subterranean formation was described. A cationic surfactant was used to manufacture asphalt-in-water emulsion. The emulsion was broken underground by following it with a caustic solution. While this can prove effective in some cases, in reality, it is very difficult to ensure that the breaker fluid follows the same path as the emulsion; therefore it is very difficult to ensure that all the emulsion is broken.

The use of an oil-in-water emulsion to seal gas formations has also been described previously in “Application of Emulsion Flow for Sealing Leaky Gas Wells” by Zeidani et al. (Conference paper, Canadian International Petroleum Conference, Jun. 13-15, 2006 2006, Calgary, Alberta). The authors relied on the capture of the small droplets by the formation to seal it. This method is not expected to work in formations with large porosity that are causing extreme cases of lost circulation; the emulsion droplets are much too small relative to the cavity size.

It is an object of the present invention to provide an improved lost circulation agent to seal subterranean formations. The present invention aims to better satisfy this need.

### SUMMARY OF THE INVENTION

Unlike other emulsion sealing methods where the emulsion is prepared such that the emulsion is either filtered by the formation or breaks once in contact with a second breaker fluid, the current invention relies on the emulsion to break once in contact with the formation fluids, triggered by a chemical reaction of the surfactant with the formation fluids. The careful selection and addition of a surfactant that is soluble in the water used to manufacture the emulsion and insoluble in the presence of the formation water permits the emulsion described according to the present invention to seal the subterranean formation.

Based on the previous work in this field, an oil-in-water emulsion capable of self-breaking in the presence of the formation or formation fluids would be very beneficial for sealing subterranean formations.

According to one aspect of the present invention there is provided an oil in water emulsion for use in sealing a subterranean formation, said oil-in-water emulsion comprising an aqueous continuous phase and a hydrocarbon internal phase, said emulsion stabilized by a surfactant, wherein said surfactant has the following properties: (i) has an HLD (“Hydrophilic Lipophilic Deviation” of a surfactant, see equations below at paragraphs 030-032) that is less than 0; (ii) is soluble in the water used to manufacture the emulsion, and (iii) is insoluble in the subterranean water.

In yet a further aspect of the present invention, there is provided a method for preparing an oil-in-water emulsion comprising: combining water and a surfactant to form an aqueous solution; combining said aqueous solution with a hydrocarbon and mixing until said oil-in water emulsion is formed, wherein said surfactant comprises the following properties: (i) has an HLD that is less than 0; (ii) is soluble in the water used to manufacture the emulsion, and (iii) is insoluble in the subterranean water.

Another advantage of the present invention is the ability to recover the hydrocarbon component of the emulsion if applied in the producing formation.

These and other features, aspects and advantages of the present invention will become better understood with regard to the following description.

### DESCRIPTION OF THE DRAWINGS

FIG. 1 is a graph of pressure at the inlet of the core and mass of fluids produced as a function of time, over the injection of the emulsion for example 1.

FIG. 2 is a graph of pressure at the inlet of the core and mass of fluids produced as a function of time, during the injection of water that follows the emulsion injection for example 1.

FIG. 3 shows photographs of the core after the experiment for example 1.

FIG. 4 is a graph of pressure at the inlet of the core and mass of fluids produced as a function of time in example 2.

FIG. 5 is a graph of pressure at the inlet of the core and mass of fluids produced as a function of time during the injection of water that follows the emulsion injection for example 2.

FIG. 6 shows photographs of the core after the experiment for example 2.

FIG. 7 is a graph showing effective permeability during the water injection that follows the emulsion injection.

### DETAILED DESCRIPTION OF THE INVENTION

The current invention relates to a novel method for sealing a subterranean formation using an oil in water emulsion. The present invention also relates to a process for preparing an oil-in-water emulsion, and to the emulsions obtained thereby.

The term “oil”, as used herein, including the claims, comprises oil or hydrocarbon of any type or composition.

The oil-in-water emulsion of the present invention comprises a hydrocarbon, an aqueous medium and the use of a surfactant to emulsify and stabilise the emulsion. The emulsion is an oil-in-water emulsion where the oil is distributed as small oil droplets within a water or aqueous continuous phase.

The emulsions and methods of making such emulsions according to the present invention can be used to seal a formation in order to prevent other fluids to enter.

The hydrocarbon phase used for making the emulsion should preferably comprise hydrocarbons previously produced from the same formation where the emulsion will be injected. In addition, the hydrocarbon should be naturally occurring bitumen or asphalt. Ideally, the hydrocarbon will be tacky under formation temperature, such that the breaking of the emulsion forms a solid mass capable of at least partially sealing the wellbore's walls. In using produced oil from the reservoir, such as naturally occurring bitumen, compatibility between the injected fluid comprising the emulsion and the reservoir is maintained.

An advantage of the present invention is the ability to later recover the hydrocarbon used to seal the formation. While being economically beneficial, it also considerably reduces the chance of formation damage when using this type of sealant. For example, if the sealant is applied to a bitumen formation, it can be recovered by subsequent steaming of the formation, a standard process to produce bitumen from a bitumen-laden formation.

While it may be preferable to use the same hydrocarbon as what is present in the reservoir to manufacture the emulsion, if desired, any other type of hydrocarbon could also be used.

It is an advantage of the present invention to have the breaking of the emulsion triggered by contact of the emulsion with formation fluids. This ensures that the emulsion breaks only where needed.

Another advantage of the present invention is that standard lost circulation materials can be added to the emulsion so to give structural strength to the hydrocarbon seal left by the broken emulsion in order to better seal larger cavities.

A further advantage of the present invention is the ability to use the emulsion as a drilling fluid. The emulsion's rheology can be modified using water soluble polymers such that its rheology is suitable for drilling.

An additional advantage is the ability to use the emulsion as a pill or slug. In this application, a water compatible with the emulsion can be injected first, followed by the emulsion, followed by a small emulsion compatible spacer, and then followed by a water not compatible with the emulsion. This ensures that the emulsion breaks in the formation, that the emulsion is pushed into the formation and that the emulsion does not stay within the wellbore. This procedure can also be applied using a packer to isolate the formation and prevent fluid returns from the procedure to the surface.

The methods and compositions of this invention incorporate a surfactant to stabilise the oil-in-water emulsion. The surfactant is added to the hydrocarbon and water solution during the preparation of the emulsion. According to the invention, the chemical nature of the surfactant compound may be anionic, cationic or non-ionic. Preferably, the surfactant that is used is an anionic surfactant.

In order to ensure emulsion stability, the surfactant is selected according to the oil and brine chemistries of the reservoir. The surfactant should have the following properties: (a) has an HLD value that is effective in producing an oil-in water emulsion; (b) is soluble in the water used to manufacture the emulsion, and (c) is insoluble in the subterranean formation water.

The selection of a suitable surfactant is also based on the oil and water chemistries of the hydrocarbon and aqueous phase, for example, by using well-known theories such as the HLD Theory of Jean-Louis Salager. The HLD number (or Hydrophilic Lipophilic Deviation) of a surfactant is a well known quantity and needs no extended explanation herein. The reader is referred to J. L. Salager et al., “Principles of Emulsion Formulation Engineering,” in Dinesh O. Shah and K. L Mittal, eds., Adsorption and Aggregation of Surfactants in Solution (CRC Press, 2002) 501-523. Using the HLD equations, the effects of the salts present in the aqueous phase (e.g. Na+, Ca2+, Mg2+, etc) can be predicted. For example, the salt content of the water in the aqueous phase is known to affect the cloud point of non-ionic surfactants and sometimes will trigger precipitation of anionic surfactants. In the foregoing and hereinafter, HLD means Salager's equation and for the reader's reference, the equations for non-ionic and ionic surfactants are reproduced below. The HLD equations for all other types of surfactants have not been reproduced below but are accessible by referring to Salager's HLD Theory as described above.

The HLD of a surfactant, for a non-ionic surfactant is:

HLD=α−EON−kACN−bS+aC_{A}+c(T−T_{ref})

wherein EON is the average number of ethylene oxide groups per non-ionic surfactant molecule, ACN is the alkane carbon number, S is the salinity as wt % NaCl, C_{A} is the alcohol concentration, T is the Temperature and α is a parameter that is characteristic of the surfactant lipophilic group type and branching. It increases linearly with the number of carbon atoms in the alkyl tail. The k, a, b, and c are numerical coefficients.

The HLD equation of a surfactant, for an ionic surfactant is:

HLD=σ+ln(S)−kACN+c(T−T_{ref})+aA

wherein σ is a parameter that is characteristic of the surfactant, S is the salinity as wt % NaCl, ACN is the alkane carbon number, T is the temperature, and A is the percentage of alcohol added. k, c and a are numerical coefficients.

When the HLD>0, a Winsor type II phase behaviour is exhibited and it is the oil in the phase that contains most of the surfactant. At HLD=0 formulation, the affinity of the surfactant is the same for both phases and a very low minimum of interfacial tension is exhibited. When the HLD<0 the affinity of the surfactant for the aqueous phase dominates, and a so-called Winsor type I phase behaviour is exhibited in which a surfactant-rich aqueous phase is in equilibrium with an essentially pure oil phase.

As such, it is preferred to select a surfactant with an HLD of less than zero, when present in the water used to manufacture the emulsion.

In addition, it is also preferred that the surfactant is insoluble in the subterranean formation water. In other words, the surfactant must either precipitate in the subterranean formation water, or must have a HLD of zero or greater than zero in the subterranean formation water.

In a preferred embodiment, an anionic surfactant that precipitates in the presence of calcium ions is used. Examples of anionic surfactants that could be considered for the oil-in-water emulsion of the present invention include and are not limited to:
Linear alkyl benzene sulfonate
Branched alkyl benzene sulfonate
Linear alkyl sulfonate
Branched alkyl sulfonate
Linear sulfate
Branched sulfate

Surfactants in the sulfonate family are especially interesting since they are usually soluble in fresh water while being insoluble in the presence of calcium ions. Subterranean formations will often show high levels of calcium ion, while drilling fluids are often manufactured with fresh water. The calcium gradient between the drilling fluid and the subterranean formation is in those situations an ideal trigger mechanism for breaking the emulsion.

In a second embodiment of this invention, a non-ionic surfactant with a cloud point temperature equal or lower than the formation temperature is selected. It is imperative to assure that the temperature of the drilling fluid stays below the formation temperature, and below the cloud point of the surfactant. Examples of non-ionic surfactants that could be considered for the oil-in-water emulsion of the present invention include and are not limited to:
Nonyl phenol polyethoxyalte
Linear alcohol polyethoxylates
Branched alcohol polyethoxylates
Caster oil polyethoxylates
Synthetic alcohol polyethoxylates

In a third embodiment of this invention, a non-ionic surfactant is selected, such that the surfactant has a cloud point above formation temperature when present in the emulsion water and a cloud point below formation temperature when present in the subterranean formation water. In this embodiment, it is necessary for the subterranean formation water to be more saline than the emulsion water. The difference in salt concentration affects the cloud point of the selected non-ionic surfactant. The higher the salt concentration, the lower the cloud point temperature of the selected non-ionic surfactant will be. Examples of non-ionic surfactants that could be considered for the oil-in-water emulsion of the present invention include and are not limited to:
Nonyl phenol polyethoxyalte
Linear alcohol polyethoxylates
Branched alcohol polyethoxylates
Caster oil polyethoxylates
Synthetic alcohol polyethoxylates

In a fourth embodiment of this invention, an anionic surfactant is selected such that the surfactant has a neutral charge at neutral pH and a negative charge at a pH higher than 7. Examples of anionic surfactants that could be considered for the oil-in-water emulsion of the present invention include and are not limited to:
Naturally occurring organic acids that are already present in the crude
Naphthalene sulfonic acids
Naphthalene carboxylic acids

In a fifth embodiment of this invention, a cationic surfactant is selected such that the surfactant has a neutral charge at neutral pH and a positive charge at a pH less than 7. Examples of cationic surfactants that could be considered for the oil-in-water emulsion of the present invention include and are not limited to:
Tallowalkyl amines
Cocoalkyl amines
Dicocoalkyl amines
Oleyl-dimethyl amines

It should be noted that sometimes, the alkyl chain in some of the surfactants mentioned above can improve the surfactant's ability to stay dissolved in concentrated brine solutions. In addition, linear alkyl chains are preferable to branched alkyl chains since they are more readily biodegradable. The selection of other typical surfactants would be known to one familiar with the art.

A polymer may optionally be added to the aqueous medium prior to emulsification. A polymer may be used to increase the viscosity of the emulsion and therefore, also increase the stability of the emulsion to sedimentation or creaming. A suitable polymer may be selected from the standard polymer family used in drilling muds such as xanthan gum or chemically modified cellulose gum.

The emulsions of this invention are prepared by mixing an aqueous phase with the oil phase in any manner. The oil-in-water emulsion is typically manufactured using standard emulsification equipment, such as colloidal mills or static mixers. In a particularly preferred embodiment, the emulsions of the invention are prepared using colloidal mills because of their ease of use and their adaptability to different process conditions. However, different emulsification equipment and shearing devices could also be used, as would be known to one of ordinary skill in the art.

The oil in water emulsion is formed by adding the hydrocarbon to the aqueous medium, in small aliquots or continuously and placing the mixture in a colloidal mill for a time sufficient to disperse the oil as small droplets in the continuous aqueous phase. The hydrocarbon content may vary from 0.1% to 90%, however it is preferred to have an emulsion comprising about 50% to about 70% volume percent hydrocarbon.

If the step of adding a polymer is used, the polymer can be added to the water prior to emulsification or added directly to the oil-in water emulsion.

An optional component consisting of standard lost circulation material can also be added for extreme cases of large porosity formation needing to be sealed. The lost circulation material is typically one or a combination of bentonite, polymer, solid polymer fibers (polyethylene, polypropylene, etc), sawdust, flaked cellophane, crushed or ground calcium carbonate, shredded newspaper, cotton seed hulls, and crushed walnut shells

The following laboratory test was conducted to demonstrate the effectiveness of the emulsion as a sealing agent for a subterranean formation.

### EXAMPLE 1

The emulsion sealing agent was tested in a core flood apparatus containing an unconsolidated core made from Ottawa sand of 100 to 140 mesh and with dimensions of 2″ diameter by 9″ long. A computer recorded the pressure and the cumulative weight of fluids produced versus time. The porosity was measured using gas expansion. In the gas expansion method, a known volume of nitrogen gas at a known pressure is equilibrated with the core. Once equilibrated, the pressure is measured again. Using the initial volume and pressure, the final pressure, and known fitting volumes, the pore volume of the core can be calculated. The Van der Waals correction to the ideal gas law is used to calculate the pore volume. The core initial permeability to water is measured by flowing water through the core at a known pressure and measuring the water flow rate exiting the core. The porosity was 31%, while the permeability was 5 Darcy. After the porosity and permeability measurements, the core is filled with a brine solution representing the formation being studied. In this case, the brine solution contained 30,500 ppm of sodium ions, 3,347 ppm of calcium ions, with chloride as the counter ion.

An emulsion was formulated, consisting of 70% naturally occurring bitumen, 29.8% tap water and 0.2% alkyl benzene sulfonate, sodium salt. The emulsion was manufactured using a colloidal mill model SEP 0.3B from DenimoTech A/S.

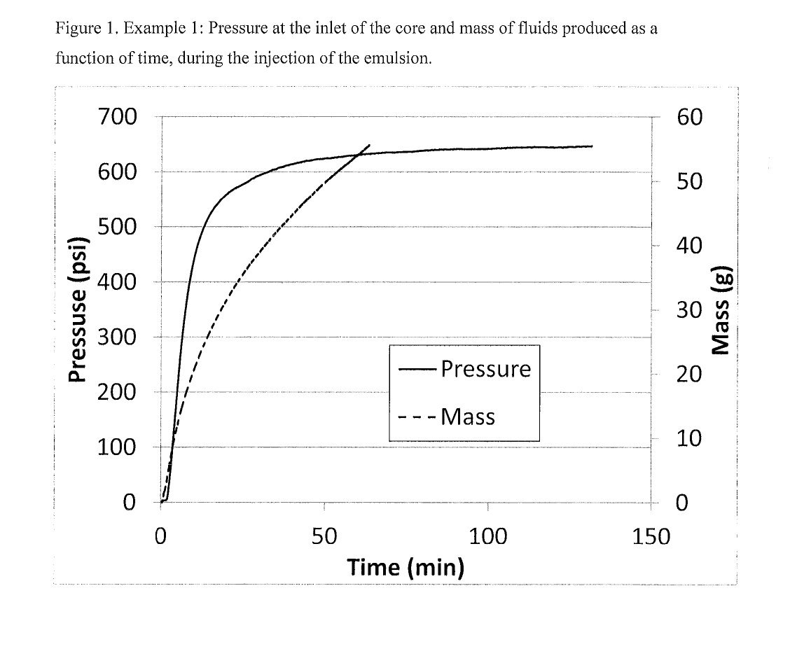

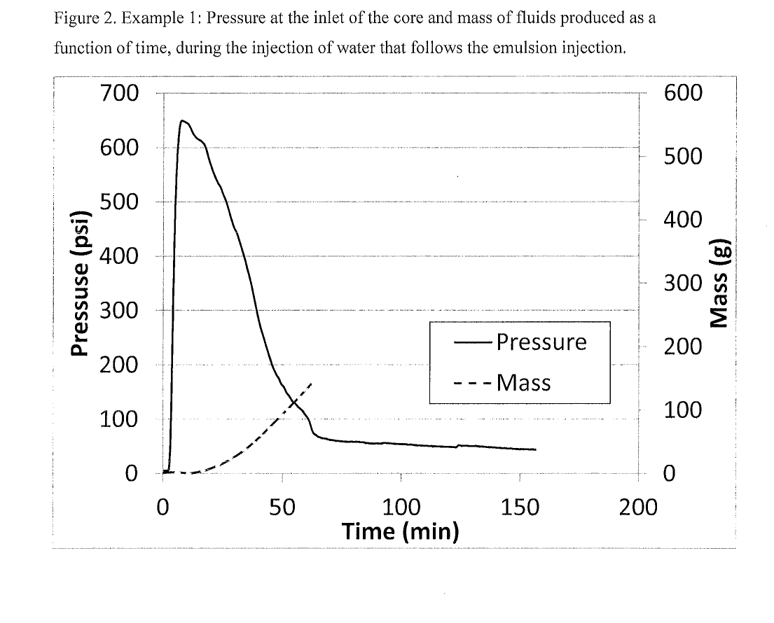

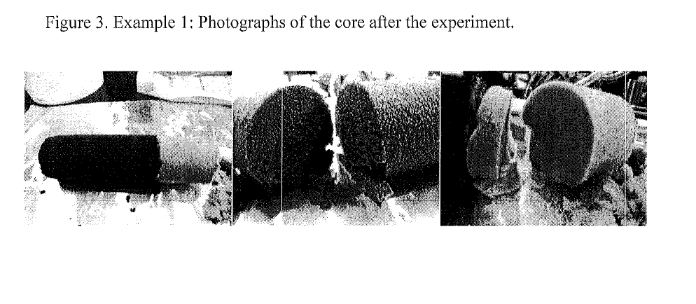

The emulsion was pumped through the core at a constant pressure of 600 psi at the pump for 0.67 pore volumes. FIG. 1 shows the pressure and mass against time of the emulsion flood. The drop of pressure at the end of the graph is when the pump shut off. After the injection of emulsion, 4.1 pore volumes of tap water are pushed through at 600 psi. FIG. 2 shows the pressure and mass response over time for the water push. Initially the pressure held above 600 psi for 18 minutes and then steadily decreased to 70 psi after an hour. The pressure then slowly decreased to 45 psi after 2.5 hours. The mass did not increase until the pressure decreased at 18 minutes. It then steadily climbed until the 4.1 pore volume was reached. FIG. 3 show the core after the run. A clear split between oil and untouched sand was noted. The water did not carry any of the oil further down the core.

### EXAMPLE 2

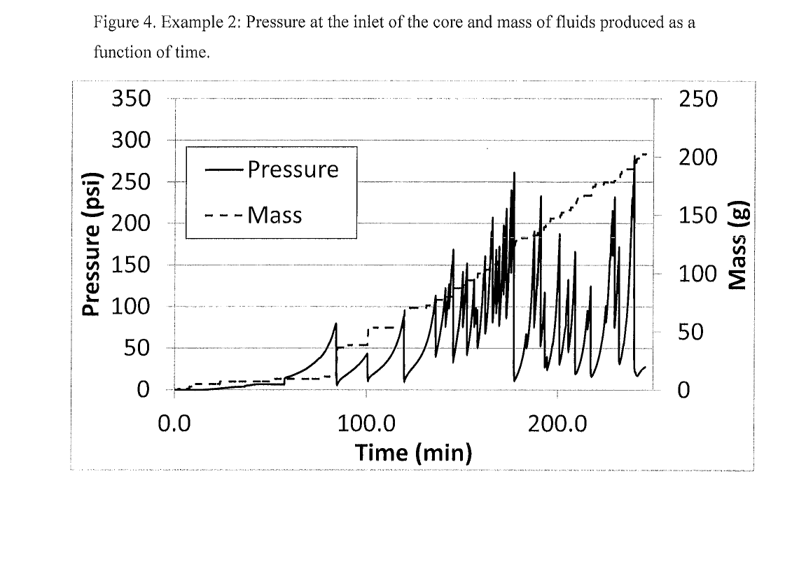

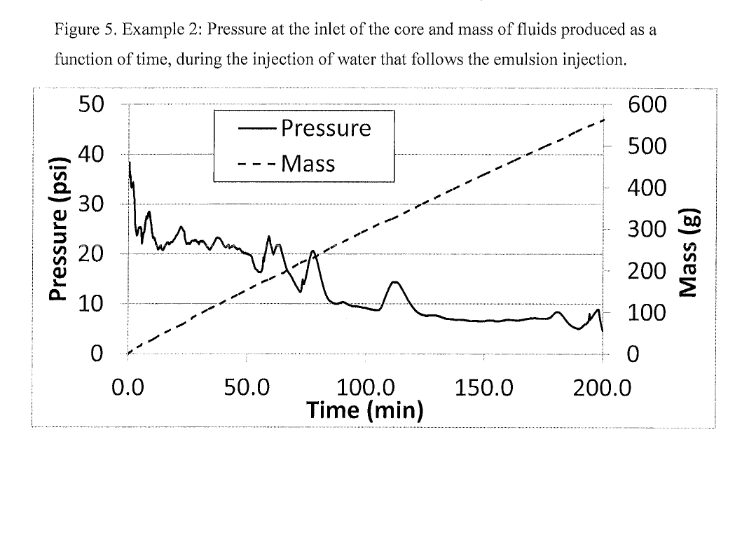

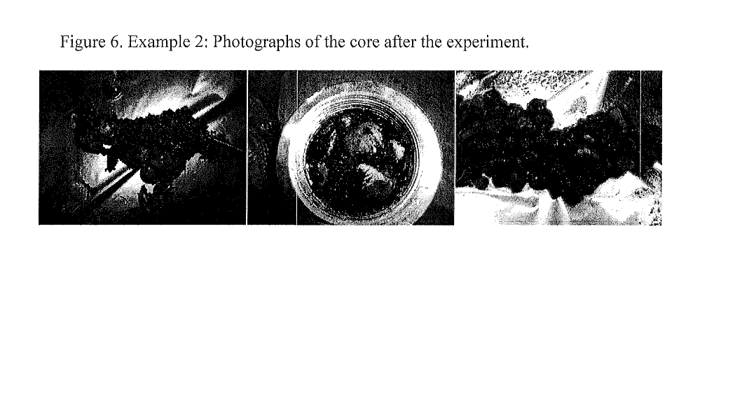

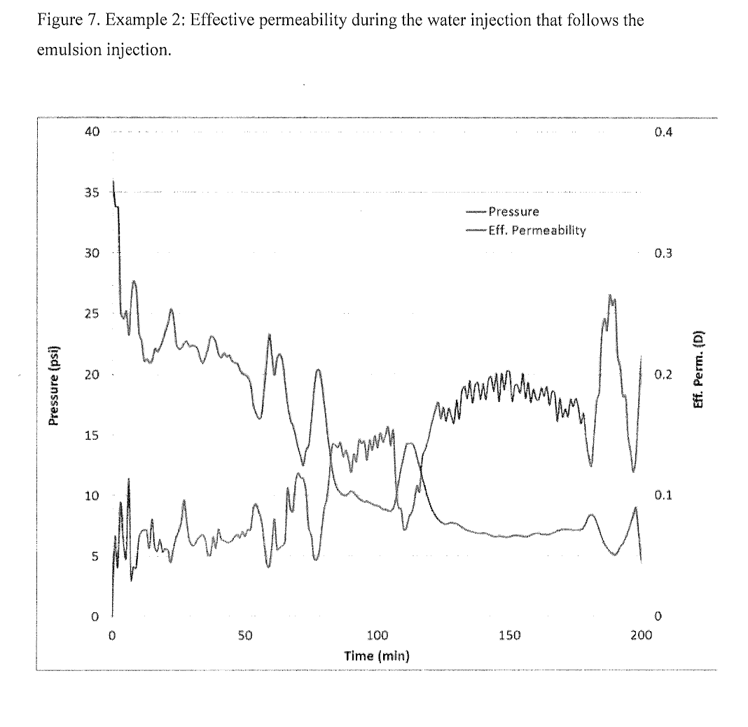

Another example was performed with the same core flood apparatus containing an unconsolidated core made from round and washed ¾″ pebbles and with dimensions of 2″ diameter by 12″ long. The same emulsion as Example 1 was used, expect that 15% by mass of a lost circulation material (LCM) mixture of saw dust and crush nut shells was added to seal the larger cavities. Half of a pore volume of LCM containing emulsion was pumped into the brine filled core at 1 ml/min. It was followed by 1.5 pore volumes of tap water at 600 psi. FIG. 4 shows the emulsion flood response. The pressure spikes show the core plugging. The mass increase is stair-like, suggesting the increase and more effective blockage of pore space. FIG. 5 shows the response to the water flood. Initially the emulsion and LCM held back 35 psi of pressure before allowing water flow. The pressure decreased to around 8 psi. FIG. 6 show an increase in LCM oil pack at the inlet of the core. The pebbles do not fall out of place, but require digging out with metal spoon. FIG. 7 shows the effective permeability of the core throughout the run. A final effective permeability of 0.15 D represents a 4,000,000 times decrease in permeability compared to the initial estimated permeability of 200,000 D.

Although embodiments of the invention have been described above, it is not limited thereto and it will be apparent to those skilled in the art that numerous modifications form part of the present invention insofar as they do not depart from the spirit, nature and scope of the claimed and described invention

1. An oil-in-water emulsion subterranean formation sealant that contains a hydrocarbon, water and a surfactant, such that the surfactant is soluble in the emulsion water and insoluble in the presence of subterranean formation water.

2. An oil-in-water emulsion, as described in claim 1, where the surfactant solubility is affected by a change of salinity, pH, calcium ion concentration or temperature in the aqueous component of the emulsion.

3. A method to seal a subterranean formation using an oil-in-water emulsion, where the emulsion demulsifies in the presence of the subterranean formation water.

4. A method as described in claim 3, where the emulsion demulsifies responsive to a change in salinity, pH, calcium ion concentration or temperature.

5. A method as described in claim 4, where the emulsion is used as a drilling fluid.

6. A method as described in claim 4, where the emulsion is used as a pill during drilling activities.

7. The process of claim 4 with process steps comprising:
a. mixing a surfactant, a hydrocarbon and water to form an oil-in-water emulsion which will demulsify in the presence of a subsurface formation's fluid;
b. injecting the emulsion into a wellbore to the formation;
c. permitting the demulsification of the emulsion near the well-bore's intersection with the subsurface formation responsive to the formation's fluid to form at least a partial seal between the wellbore and the formation.
